(19) United States
(12) Patent Application Publication
(10) Pub. No.: US 2016/0139757 A1
(43) Pub. Date: May 19, 2016

(54) DATA CORRECTION APPARATUS, DISPLAY DEVICE HAVING THE DATA CORRECTION APPARATUS, AND DATA CORRECTION METHOD

(71) Applicant: SAMSUNG DISPLAY CO., LTD., Yongin-City (KR)

(72) Inventor: Sung Yeol BAEK, Anyang-si (KR)

(21) Appl. No.: 14/681,566

(22) Filed: Apr. 8, 2015

(30) Foreign Application Priority Data
Nov. 13, 2014 (KR) 10-2014-0158026

(51) Int. Cl. G06F 3/0485

(52) U.S. Cl. CPC G06F 3/0485

(57) ABSTRACT

A data correction apparatus includes a pattern detector, a scroll detector, and a data processor. The pattern detector detects a predetermined pattern area in raw frame data and outputs pattern data corresponding to the predetermined pattern area. The scroll detector detects a scroll operation based on user manipulation data and outputs scroll data corresponding to the scroll operation. The data processor outputs corrected frame data or non-corrected frame data based on the raw frame data, the pattern data, and the scroll data. The corrected frame data includes first area data and second area data. The first area is data identical to a counterpart of the raw frame data, and the second area data to be obtained by correcting a counterpart of the raw frame data. The non-corrected frame data is identical to the raw frame data.

### CROSS-REFERENCE TO RELATED APPLICATION

Korean Patent Application No. 10-2014-0158026, filed on Nov. 13, 2014, and entitled, “Data Correction Apparatus, Display Device Having the Data Correction Apparatus, and Data Correction Method,” is incorporated by reference herein in its entirety.

### BACKGROUND

1. Field

One or more embodiments described herein relate to a data correction apparatus, a display device having a data correction apparatus, and a data correction method.

2. Description of the Related Art

Many electronic devices have displays. Most of these devices are user controlled. For example, a user may control the functions of an electronic device with an input device, often in various operating states and/or during the execution of programs. When all information of an image cannot be displayed at the same time on a display screen because the size of the screen or device is limited, a user may control the position of the image by vertically or horizontally scrolling the image. However, during scrolling, the image may tremble, vibrate, or flicker, e.g., generically referred to as a flicker phenomenon. These effects may become pronounced when the image has a particular pattern such as a stripe pattern, checker pattern, block pattern, or another pattern.

### SUMMARY

In accordance with one or more embodiments, a data correction apparatus includes a pattern detector to detect a predetermined pattern area in raw frame data and to output pattern data corresponding to the predetermined pattern area; a scroll detector to detect a scroll operation based on user manipulation data and to output scroll data corresponding to the scroll operation; and a data processor to output corrected frame data or non-corrected frame data based on the raw frame data, the pattern data, and the scroll data, wherein the corrected frame data includes first area data and second area data, the first area data identical to a counterpart of the raw frame data and the second area data to be obtained by correcting a counterpart of the raw frame data, and wherein the non-corrected frame data is identical to the raw frame data.

The data processor may output the corrected frame data based on the pattern data indicating existence of the predetermined pattern area, the scroll data indicating existence of the scroll operation, and the scroll data indicating that a scroll speed corresponding to the scroll operation exceeds a predefined scroll speed, and output the non-corrected frame data based on to the pattern data indicating nonexistence of the predetermined pattern area, the scroll data indicating nonexistence of the scroll operation, or the scroll data indicating that the scroll speed corresponding to the scroll operation does not exceed the predefined scroll speed.

The raw frame data may include information corresponding to grayscale values of a plurality of pixels of a frame, and the pattern detector may detect the grayscale values of the pixels from the raw frame data, black pixels with a grayscale value less than a first grayscale value and white pixels with a grayscale value less than a second grayscale value, and a predetermined pattern area that includes the black pixels and the white pixels.

The first area data may correspond to an area other than the predetermined pattern area and the second area data corresponds to the predetermined pattern area. The corrected frame data may include second area data in which the black pixels are corrected to have a greater grayscale value than in the raw frame data and the white pixels are corrected to have a smaller grayscale value than in the raw frame data.

The predetermined pattern area may include a row stripe pattern area including m pixels in a row direction and n pixels in a column direction, the black pixels or the white pixels continuously arranged in the row direction, and the black pixels and the white pixels alternately arranged in the column direction, and a column stripe pattern area including m pixels in the row direction and n pixels in the column direction, the black pixels or the white pixels continuously arranged in the column direction, and the black pixels and the white pixels alternately arranged in the row direction.

The data processor may generate the corrected frame data for part of the raw frame data corresponding to the row stripe pattern area based on the scroll operation associated with a movement in the column direction, and generate the corrected frame data for part of the raw frame data corresponding to the column stripe pattern area based on the scroll operation being associated with a movement in the row direction.

The data processor may output corrected frame data with larger variations in grayscale value in pixels close to a center of the predetermined pattern area than in pixels less close to the center of the predetermined pattern area.

The data processor may output corrected frame data with larger variations in grayscale value for a scroll speed close to an odd number multiple of a driving frequency of a display device than for a scroll speed close to an even number multiple of the driving frequency of the display device.

Each of the pixels may include a plurality of sub-pixels to emit light of different, and the pattern detector may determine black pixels to correspond to ones having an average of grayscale values of sub-pixels less than the first grayscale value, and white sub-pixels to correspond to ones having an average of grayscale values of sub-pixels greater than the second grayscale value. The sub-pixels may respectively emit red, green, and blue light. The pattern detector may provide the raw frame data to the data processor, and wherein the data processor is to receive the raw frame data from the pattern detector.

In accordance with one or more other embodiments, a display device includes a data corrector to output corrected frame data or non-corrected frame data, the corrected frame data based on based on raw frame data; and a display panel to display an image corresponding to the corrected frame data or the non-corrected frame data, wherein the data corrector includes: a pattern detector to detect a predetermined pattern area from the raw frame data and to output pattern data corresponding to the predetermined pattern area, a scroll detector to detect a scroll operation based on user manipulation data and to output scroll data regarding the scroll operation, and a data processor to output the corrected frame data or the non-corrected frame data based on the raw frame data, the pattern, data and the scroll data, wherein the corrected frame data includes first area data identical to a counterpart of the raw frame data and second area data obtained by correcting a counterpart of the raw frame data, and wherein the non-corrected frame data is identical to the raw frame data.

The data processor may output the corrected frame data based on the pattern data indicating existence of the stripe pattern area, the scroll data indicating existence of the scroll operation, and the scroll data indicating that a scroll speed corresponding to the scroll operation exceeds a predefined scroll speed, and output the non-corrected frame data based on the pattern data indicating nonexistence of the predetermined pattern area, the scroll data indicating nonexistence of the scroll operation, or the scroll data indicating that the scroll speed corresponding to the scroll operation does not exceed the predefined scroll speed.

The raw frame data may include information regarding grayscale values of a plurality of pixels in a frame, and the pattern detector may detect the grayscale values of the pixels from the raw frame data, black pixels with a grayscale value less than a first grayscale value and white pixels with a grayscale value less than a second grayscale value, and a predetermined pattern area that includes the black pixels and the white pixels.

The first area data may correspond to an area other than the predetermined pattern area and the second area data corresponds to the predetermined pattern area. The corrected frame data may include second area data in which the black pixels are corrected to have a greater grayscale value than in the raw frame data and the white pixels are corrected to have a smaller grayscale value than in the raw frame data.

The predetermined pattern area may include a row stripe pattern area including m pixels in a row direction and n pixels in a column direction, the black pixels or the white pixels continuously arranged in the row direction, and the black pixels and the white pixels alternately arranged in the column direction, and a column stripe pattern area including m pixels in the row direction and n pixels in the column direction, the black pixels or the white pixels continuously arranged in the column direction, and the black pixels and the white pixels alternately arranged in the row direction.

The data processor may generate the corrected frame data for part of the raw frame data corresponding to the row stripe pattern area based on the scroll operation associated with a movement in the column direction, and the corrected frame data for part of the raw frame data corresponding to the column stripe pattern area based on the scroll operation being associated with a movement in the row direction.

The data processor may output corrected frame data with larger variations in grayscale in pixels close to a center of the predetermined pattern area than in pixels less close to the center of the predetermined pattern. The data processor may output corrected frame data with larger variations in grayscale for a scroll speed close to an odd number multiple of a driving frequency of a display device than for a scroll speed close to an even number multiple of the driving frequency of the display device.

In accordance with one or more other embodiments, a data correction method includes detecting a predetermined pattern area based on raw frame data and outputting pattern data regarding the predetermined pattern area; detecting a scroll operation based on user manipulation data and outputting scroll data regarding the scroll operation; and outputting corrected frame data or non-corrected frame data based on the raw frame data, the pattern data, and the scroll data.

Outputting the corrected frame data or the non-corrected frame data may include outputting the corrected frame data based on the pattern data indicating existence of the predetermined pattern area, the scroll data indicating existence of the scroll operation, and the scroll data indicating that a scroll speed corresponding to the scroll operation exceeds a predefined scroll speed, and outputting the non-corrected frame data based on the pattern data indicating the nonexistence of the stripe pattern area, the scroll data indicating the nonexistence of the scroll operation, or the scroll data indicating that the scroll speed corresponding to the scroll operation does not exceed the predefined scroll speed.

The raw frame data may include information corresponding to grayscale values of a plurality of pixels in a frame, and detecting the predetermined pattern area may include detecting the grayscale values of the pixels from the raw frame data, black pixels with a grayscale value less than a first grayscale value, and white pixels with a grayscale value less than a second grayscale value, and detecting a predetermined pattern area formed by the black pixels and the white pixels.

Outputting the corrected frame data may include generating corrected frame data in which the black pixels are corrected to have a greater grayscale value than in the raw frame data and the white pixels are corrected to have a smaller grayscale value than in the raw frame data.

Outputting the corrected frame data may include outputting corrected frame data with larger variations in grayscale value in pixels close to a center of the predetermined pattern area than in pixels less close to the center of the predetermined pattern.

Outputting the corrected frame data may include outputting corrected frame data with larger variations in grayscale value for a scroll speed close to an odd number multiple of a driving frequency of a display device than for a scroll speed close to an even number multiple of the driving frequency of the display device.

### BRIEF DESCRIPTION OF THE DRAWINGS

Features will become apparent to those of skill in the art by describing in detail exemplary embodiments with reference to the attached drawings in which:

FIG. 1 illustrates an embodiment of a display device;

FIG. 2 illustrates an embodiment of pixels and sub-pixels;

FIG. 3 illustrates an embodiment of a data correction unit;

FIG. 4 illustrates another embodiment of a data correction unit;

FIG. 5 illustrates an embodiment of a data correction method;

FIG. 6 illustrates an example of raw frame data;

FIG. 7 illustrates an embodiment of corrected frame data;

FIG. 8 illustrates another embodiment of corrected frame data;

FIG. 9 illustrates another embodiment of corrected frame data;

FIG. 10 illustrates another embodiment of corrected frame data;

FIGS. 11(a), 11(b), and 11(c) illustrate an embodiment of raw frame data for various scroll speeds

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. In the drawings, the dimensions of layers and regions may be exaggerated for clarity of illustration. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

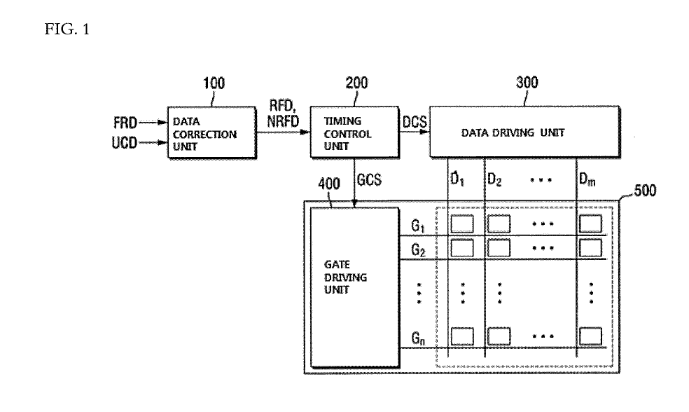

FIG. 1 illustrates an embodiment of a display device which includes a data correction unit 100, a timing control unit 200, a data driving unit 300, a gate driving unit 400, and a display panel 500.

The data correction unit 100 receives raw frame data FRD and user manipulation data UCD and outputs corrected frame data RFD or non-corrected frame data NRFD. Each of the raw frame data FRD, the corrected frame data RFD, and non-corrected frame data NRFD may include information (e.g., RGB image data) regarding an image to be displayed on the display panel 500.

The image may be divided into one or more frames and may be displayed in units of frames. The frames may be consecutively displayed on the display panel 500. Each frame may include data for a set of pixels. Each of the raw frame data FRD, the corrected frame data RFD, and the non-corrected frame data NRFD may include, for example, information regarding the grayscale values of the pixels.

A flicker phenomenon may occur in part of a frame with a particular pattern during a scroll operation performed by a user. In order to reduce the flicker phenomenon, the data correction unit 100 may generate the corrected frame data RFD by correcting the grayscale values for pixels in the raw frame data FRD. Through the data correction unit 100, the likelihood of a flicker phenomenon in a particular pattern area of a frame during a scroll operation performed by a user may be reduced or prevented.

Referring to FIG. 1, the data correction unit 100 is illustrated in advance of the timing control unit 200 along the signal path. In another embodiment, the data correction unit 100 may be between the timing control unit 200 and the data driving unit 300, or may be inside the timing control unit 200. In one embodiment, the data correction unit 100 may be implemented as a separate device from the display device.

The timing control unit 200 generates a data driving unit control signal DCS for controlling the data driving unit 300 and a gate driving unit control signal GCS for controlling the gate driving unit 400 based on the corrected frame data RFD or the non-corrected frame data NRFD. The data driving unit control signal DCS may include, for example, an image data signal, which contains information of an image to be displayed, a horizontal start signal, an inverted signal, and an output enable signal. Some of these signals may be optional. The gate driving unit control signal GCS may include a vertical start signal, a gate clock signal, and an output enable signal, but some of these signals may be optional. In other embodiments, a different set of signals may be including in the data driving unit control signal DCS and/or the gate driving unit control signal GCS for controlling the data driving unit 300 and the gate driving unit 400, respectively.

The data driving unit 300 generates first through m-th data signals based on the data driving unit control signal DCS, and generates first through n-th gate signals based on the gate driving unit control signal GCS.

The display panel 500 displays an image corresponding to the first through m-th data signals and the first through n-th gate signals. The first through m-th data signals may correspond to the corrected frame data RFD or the non-corrected frame data NRFD, e.g., the display panel 500 may display an image corresponding to the corrected frame data RFD or the non-corrected frame data NRFD.

In the display panel 500, a plurality of pixels, which display colors, are formed at intersections of first through m-th data lines D₁ through Dₘ and first through n-th gate lines G₁ through Gₙ. The first through m-th data lines D₁ through Dₘ extend from the data driving unit 300 to the display panel 500. The first through n-th gate lines G₁ through Gₙ extend from the gate driving unit 400 to the display panel 500.

Each pixel may include a light-emitting unit connected to a switching device. When the display device is an organic light-emitting display device, the light-emitting unit may include a light-emitting diode. When the display device is a liquid crystal display device, the light-emitting unit may include a liquid crystal capacitor and a liquid crystal layer. The display device may be a different type of display in other embodiments.

When an image with a particular pattern (e.g., a stripe pattern having stripes of two colors alternately arranged) is displayed on the display panel 500 and is moved by a scroll operation performed by a user, the two colors may be alternately displayed at a particular pixel. The data driving unit 300 may display a predetermined color at each pixel by applying a data signal with a voltage corresponding to the predetermined color to the corresponding pixel. If the grayscale levels of the two colors that alternately appear at the particular pixel have too large of a difference, the voltage of a data signal applied to the particular pixel may severely fluctuate. Fluctuations in the voltage of a data signal may cause a flicker phenomenon. However, the occurrence of the flicker phenomenon may be reduced or prevented by the data correction unit 100.

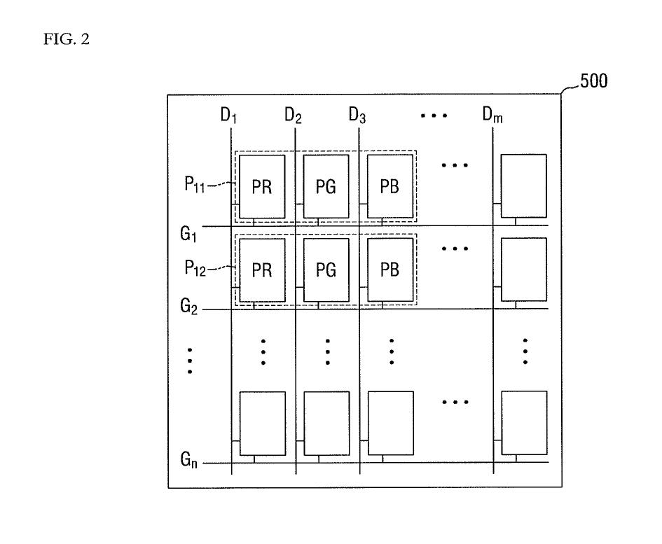

In another exemplary embodiment, a plurality of sub-pixels may be in the display panel 500. Each of the sub-pixels may emit light of a single particular color. The sub-pixels, therefore, may different from pixels in that the pixels may emits light of arbitrary colors. In this exemplary embodiment, the number of sub-pixels may be grouped to form a pixel capable of displaying arbitrary colors. This exemplary embodiment will be described with reference to FIG. 2.

FIG. 2 illustrates an embodiment of pixels and sub-pixels, where the sub-pixels are at intersections of first through m-th data lines D₁ through Dₘ and first through n-th gate lines G₁ through Gₙ. Each of the sub-pixels emit light of a single particular color only. For example, the sub-pixels may include red sub-pixels PR to emit red light, a green sub-pixels PG to emit green light, and blue sub-pixels PB to emit blue light. The red sub-pixel PR, green sub-pixel PG, and blue sub-pixel PB may be grouped together to form a single pixel.

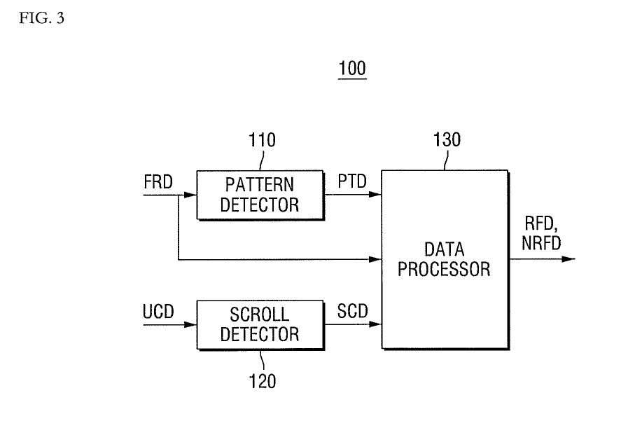

FIG. 3 illustrates an embodiment of a data correction unit, which, for example, may correspond to the data correction unit 100 in FIG. 1. Referring to FIG. 3, the data correction unit 100 includes a pattern detector 110, a scroll detector 120, and a data processor 130.

The pattern detector 110 receives raw frame data FRD, for example, from an external host, detects a predetermined pattern from each frame based on the raw frame data FRD, and outputs pattern data PTD including information regarding the detected pattern area. The predetermined pattern may be a stripe pattern, checker pattern, block pattern, or another type of pattern. The pattern detector 110 may detect the grayscale values of pixels in each frame of the raw frame data FRD, and may the predetermined pattern area based on the detected grayscale values of the pixels.

The pattern data PTD may include information regarding the presence of a predetermined pattern area in each frame and information regarding the coordinates of the predetermined pattern area in the corresponding frame. The pattern data PTD may be provided to the data processor 130. The pattern data PTD may be a digital signal with a predetermined bit length, which, for example, may vary depending on the presence of a predetermined pattern area in each frame.

The data processor 130 may determine whether to output the corrected frame data RFD or the non-corrected frame data NRFD based on the information in the pattern data PTD regarding the presence of a predetermined pattern area in each frame, and may generate the corrected frame data RFD based on the information in the pattern data PTD regarding the coordinates of a predetermined pattern area in each frame.

The scroll detector 120 may receive the user manipulation data UCD, for example, from an input device, detect information regarding a scroll operation based on the user manipulation data UCD, and output scroll data SCD including the information regarding a scroll operation.

The user manipulation data UCD includes data regarding a manipulation performed by a user using the input device (e.g., a scroll operation), and an electronic device including the display device may be manipulated and controlled based on the information regarding the scroll operation. The scroll operation may be a type which, for example, moves at least part of an image on the display panel 500. In one embodiment, the user manipulation data UCD is a digital signal with a predetermined bit length. The input device may be, for example, a touch panel, a mouse or a keyboard. When the input device is a touch panel, the input device may be formed in one body with the display device.

The scroll detector 120 may detect the presence of a scroll operation and the speed at which the image displayed on the display panel 500 is moved by the scroll operation. A method for detecting the presence of a scroll operation and the speed at which the image displayed on the display panel 500 is moved by the scroll operation may vary depending, for example, on the type of the input device. For example, when the input device is a touch panel, the presence of a scroll operation and the speed at which an image is moved by the scroll operation may be detected based on the presence of a drag from a point of touch on the touch panel and the speed of the drag. In one embodiment, when a predetermined portion of an image is programmed in advance to be moved at a predetermined speed in response to a particular point on the image being touched or in response to a predetermined operation being performed, such programming may be detected as a scroll operation.

The scroll data SCD may include information regarding the presence of a scroll operation and information regarding the speed at which an image is moved by the scroll operation. The scroll data SCD is provided to the data processor 130. In one embodiment, the scroll data SCD may be a digital signal with a predetermined bit length. The bit length of the scroll data SCD may vary, for example, depending on the presence of a scroll operation and the speed at which an image is moved by the scroll operation.

The data processor 130 may determine whether to output the corrected frame data RFD or the non-corrected frame data NRFD based on the information in the scroll data SCD regarding the presence of a scroll operation and the information in the scroll data SCD regarding the speed at which an image is moved by the scroll operation.

The data processor 130 receives the raw frame data FRD from the external host, the pattern data PTD from the pattern detector 110, and the scroll data SCD from the scroll detector 120. The data processor 130 outputs the corrected frame data RFD (which is obtained by correcting the grayscale values of one or more pixels (or sub-pixels) in the raw frame data FRD) or the non-corrected frame data NRFD (which is identical to the raw frame data FRD), and may determine whether to output the corrected frame data RFD or the non-corrected frame data NRFD based on the pattern data PTD and the scroll data SCD.

The corrected frame data RFD may be data obtained, for example, by correcting the grayscale values of one or more pixels (or sub-pixels) in each frame of the raw frame data FRD. Correction of the grayscale values of pixels in each frame of the raw frame data FRD may be performed by the data processor 130. For example, the corrected frame data RFD may include first area data identical to its counterpart of the raw frame data FRD, and second area data different from its counterpart of the raw frame data FRD. The first area data may correspond to an area other than a predetermined pattern area and the second area data may correspond to a predetermined pattern area. The grayscale values of pixels (or sub-pixels) in the second area data may be corrected.

The non-corrected frame data NRFD may have the same data as the raw frame data FRD, and may be output when the corrected frame data RFD is not output. Accordingly, the display panel 500 may display an image corresponding to the corrected frame data RFD based on the corrected frame data RFD being output, and may display an image corresponding to the non-corrected frame data NRFD based on the non-corrected frame data NRFD being output.

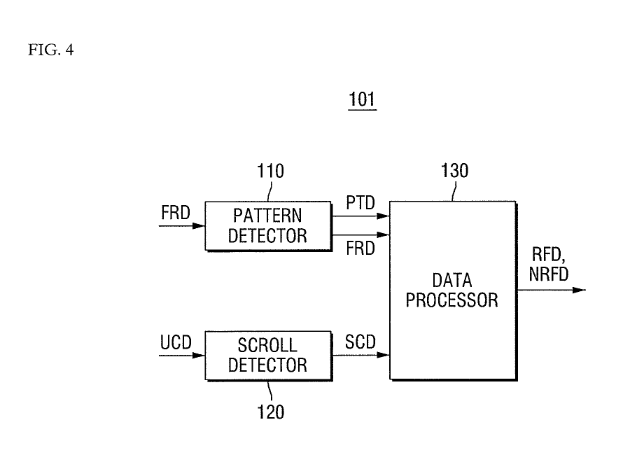

FIG. 4 illustrates another embodiment of a data correction unit 101. Referring to FIG. 4, the raw frame data FRD, which is provided, for example, by the external host, may be input to a pattern detector 110 of a data correction unit 100. The pattern detector 110 may provide the pattern data PTD and the raw frame data FRD to the data processor 130. The raw frame data FRD, which is provided, for example, by the external host, may be provided to a data processor 130. However, in this embodiment, the raw frame data FRD is not directly provided, e.g., is provided to the data processor 130 via the pattern detector 110.

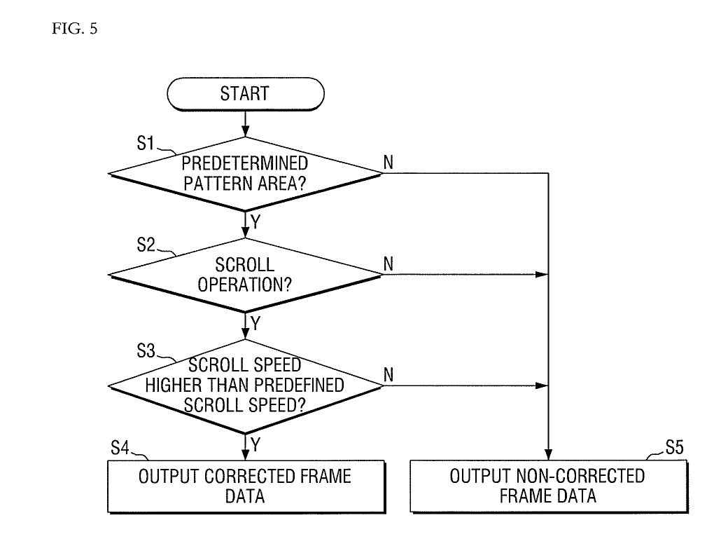

FIG. 5 illustrates an embodiment of a data correction method. Referring to FIG. 5, in operation S1, the data processor 130 analyzes the pattern data PTD. When a predetermined pattern area is detected, the data correction method proceeds to operation S2. When the predetermined pattern area is not detected, the data correction method does not proceed to S2 and the non-corrected frame data NRFD may be output. The predetermined pattern area may include a predetermined pattern, e.g., a stripe pattern or another type of pattern.

In operation S2, the data processor 130 analyzes the scroll data SCD. When a scroll operation is detected, the data correction method proceeds to operation S3. When no scroll operation is detected, the data correction method does not proceed to operation S3 and the non-corrected frame data NRFD may be output.

In operation S3, the data processor 130 analyzes the scroll data SCD to determine whether the speed at which an image is moved by the detected scroll operation exceeds a predefined scroll speed. When the scroll speed exceeds the predefined scroll speed, the data processor 130 outputs the corrected frame data RFD. When the scroll speed does not exceed the predefined scroll speed, the data processor 130 outputs the non-corrected frame data NRFD.

In one embodiment, scroll speed may be defined as the number of pixels to scroll per second. For example, an image has a scroll speed of 60 when an arbitrary area in the image is scrolled to move by 60 pixels per second. In one embodiment, the unit of hertz (Hz), which is usually used to measure the driving frequency of the display device, may be used to measure scroll speed. For example, a scroll speed of 60 Hz may indicate scrolling an image at a speed of 60 pixels per second. A different measurement unit may be used to measure the actual number of pixels to scroll per second in another embodiment.

The predefined scroll speed may be varied, for example, according to a user, application, or manufacturer setting. In one embodiment, the predefined scroll speed may be set to the same value as the driving frequency of the display device, taking into consideration a scroll speed higher than the driving frequency of the display device may cause a severe flicker phenomenon.

In one embodiment, the order of operations S1, S2, and S3 may be different from that illustrated in FIG. 5. For example, in an alternative exemplary embodiment, operations S2 and S3 may be sequentially performed and then operation S1 may be performed. In another alternative exemplary embodiment, operations S2, S1, and S3 may be sequentially performed. In these alternative exemplary embodiments, the corrected frame data RFD may be generated when the conditions of operations S1, S2, and S3 are satisfied. The non-corrected frame data NRFD may be generated when at least one of the conditions of S1, S2, or S3 is not satisfied.

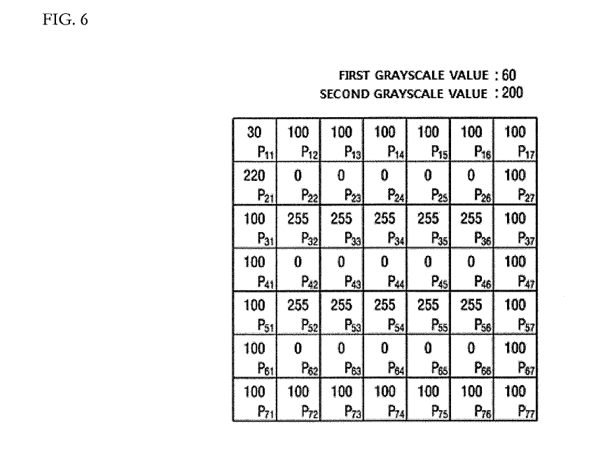

FIG. 6 illustrates a frame of raw data and the pixels corresponding to data in the frame according to an exemplary embodiment. Referring to FIG. 6, a frame for display on the display panel 500 according to the raw frame data FRD may include a plurality of pixels. Each of the pixels may emit light having a grayscale value in the range of 0 to 255. In FIG. 6, each rectangle represents a pixel and the numeric value in each rectangle represents the grayscale value of that pixel.

While grayscale value of light emitted by a pixel may be in the range of 0 to 255, the grayscale value of light emitted by a pixel may be in another range (e.g., 0 to 63 or 0 to 127) in another embodiment. The closer the grayscale value of a pixel is to 0, the darker the color of light emitted by the pixel. For example, a pixel with a grayscale value of 0 may display black. Conversely, the closer the grayscale value of light emitted by a pixel is to 255, the brighter the color displayed by the pixel. For example, a pixel emitting light with a grayscale value of 255 may display white.

The presence of a predetermined pattern area in a frame may be determined based on the grayscale values of the pixels in the frame. A predetermined pattern area may include, for example, a row stripe pattern area and a column stripe pattern area. The row stripe pattern area may be an area defined by m pixels (where m is an arbitrary natural number) in a row direction and n pixels (where n is an arbitrary natural number) in a column direction, has black pixels or white pixels continuously arranged in the row direction and has black pixels and white pixels alternately arranged in the column direction. The column stripe pattern area may be an area defined by m pixels (where m is an arbitrary natural number) in the row direction and n pixels (where n is an arbitrary natural number) in the column direction, has black pixels or white pixels continuously arranged in the column direction and has black pixels and white pixels alternately arranged in the row direction.

The term “black pixels” may correspond to pixels that emit light with a grayscale value less than a first grayscale value, and the term “white pixels” may correspond to pixels that emit light with a grayscale value greater than a second grayscale value.

For example, as illustrated in FIG. 6, the first grayscale value may be set to 60 and the second grayscale value may be set to 200. Second to sixth pixels in a second row (e.g., pixels P₂₂ to P₂₆) second to sixth pixels in a fourth row (e.g., pixels P₄₂ to P₄₆) and second to sixth pixels in a sixth row (e.g., pixels P₆₂ to P₆₆) have a grayscale value of 0, which is less than the first grayscale value of 60 and thus may be classified as black pixels. Second to sixth pixels in a third row (e.g., pixels P₃₂ to P₃₆) and second to sixth pixels in a fifth row (e.g., pixels P₅₂ to P₅₆) have a grayscale value of 255, which is greater than the second grayscale value of 200 and thus may be classified as white pixels.

An area corresponding to the second to sixth pixels (e.g., the pixels P₂₂ to P₂₆) in the second row, the second to sixth pixels (e.g., the pixels P₃₂ to P₃₆) in the third row, the second to sixth pixels (e.g., pixels P₄₂ to P₄₆) in the fourth row, the second to sixth pixels (e.g., pixels P₅₂ to P₅₆) in the fifth row, and the second to sixth pixels (e.g., pixels P₆₂ to P₆₆) in the sixth row has five rows of pixels, in each of which black pixels or white pixels are arranged in the row direction, and five columns of pixels, in each of which black pixels and white pixels are alternately arranged in the column direction, and thus may be classified as a row stripe pattern area.

A first pixel in a first row (e.g., a pixel P₁₁) has a grayscale value of 30, which is less than the first grayscale value, and thus may be considered a black pixel. However, the pixel P₁₁ is not classified as being part of the row stripe pattern area because of its neighboring pixels. A first pixel in the second row (e.g., a pixel P₂₁) has a grayscale value of 220, which is greater than the second grayscale value, and thus may be considered a white pixel. However, the pixel P₂₁ is also not classified as being part of the row stripe pattern area because of its neighboring pixels.

In the exemplary embodiment of FIG. 6, the first grayscale value and the second grayscale value are 60 and 200, respectively. In another embodiment, the first grayscale value and the second grayscale value may vary, for example, according to a user setting.

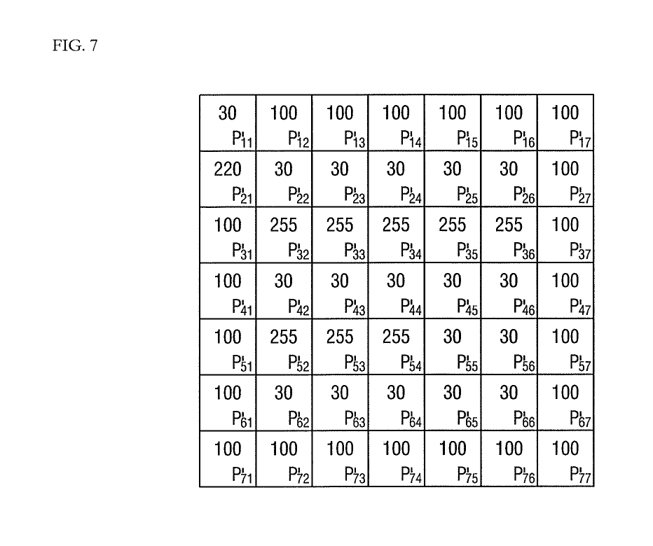

FIG. 7 illustrates a frame of corrected frame data and the pixels which are to emit light corresponding to the data in the frame according to a first exemplary embodiment. In this embodiment, pixels P₂₂ to P₂₆, P₃₂ to P₃₆, P₄₂ to P₄₆, P₅₂ to P₅₆, and P₆₂ to P₆₆ in the row stripe pattern area of the raw frame data FRD of FIG. 6 may emit light with different grayscale values from pixels P′₂₂ to P′₂₆, P′₃₂ to P′₃₆, P′₄₂ to P′₄₆, P′₅₂ to P′₅₆, and P′₆₂ to P′₆₆, respectively, in a corresponding area of the corrected frame data RFD of FIG. 7.

For example, referring to FIGS. 6 and 7, black pixels in the row stripe pattern area of the raw frame data FRD have a grayscale value of 0 in the raw frame data FRD, whereas black pixels in the corresponding row stripe pattern area of the corrected frame data RFD have a grayscale value of 30. Thus, the grayscale values of the black pixels in the row stripe pattern area of the raw frame data FRD may be increased by 30 in the corrected frame data RFD. In the exemplary embodiment of FIG. 7, the amount by which the grayscale values of the black pixels in the row stripe pattern area of the raw frame data FRD are increased in the corrected frame data RFD is set to 30. However, this value may be different in other embodiments. For example, the amount by which the grayscale values of the black pixels in the row stripe pattern area of the raw frame data FRD are increased may be varied according to a user setting.

Pixels outside the row stripe pattern area of the corrected frame data RFD, e.g., pixels P′₁₁ to P′₁₇, P′₂₁, P′₂₇, P′₃₁, P′₃₇, P′₄₁, P′₄₇, P′₅₁, P′₅₇, P′₆₁, P′₆₇, and P′₇₁ to P′₇₇, may emit light with the same grayscale values as their respective counterparts of the raw frame data FRD.

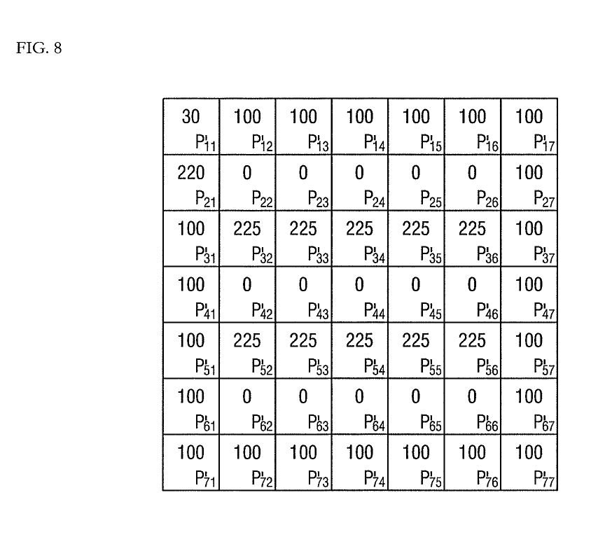

FIG. 8 illustrates a frame of corrected frame data and the pixels which are to emit light corresponding to the data in the frame according to a second exemplary embodiment. The exemplary embodiment of FIG. 8 is the same as the exemplary embodiment of FIG. 7, with an exception. Referring to FIG. 8, the grayscale values of white pixels, rather than black pixels, in a row stripe pattern area may be varied.

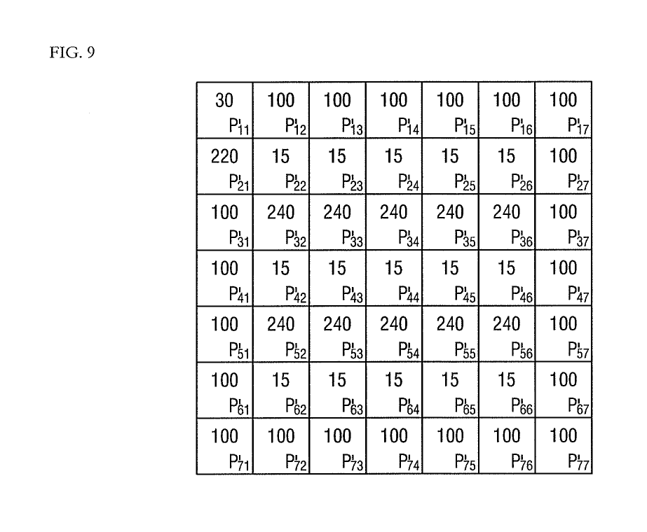

FIG. 9 illustrates a frame of corrected frame data and the pixels which are to emit light corresponding to the data in the frame according to a third exemplary embodiment. The exemplary embodiment of FIG. 9 is the same as the exemplary embodiment of FIG. 7 with an exception. Referring to FIG. 9, in the corrected frame data RFD, the grayscale values of black pixels in a row stripe pattern area may be increased by 15, rather than by 30, and the grayscale values of white pixels in the row stripe pattern area may be lowered by 15. Thus, the grayscale values of the black pixels in the row stripe pattern area and the grayscale values of the white pixels in the row stripe pattern area may both be varied by as much as 30 in total.

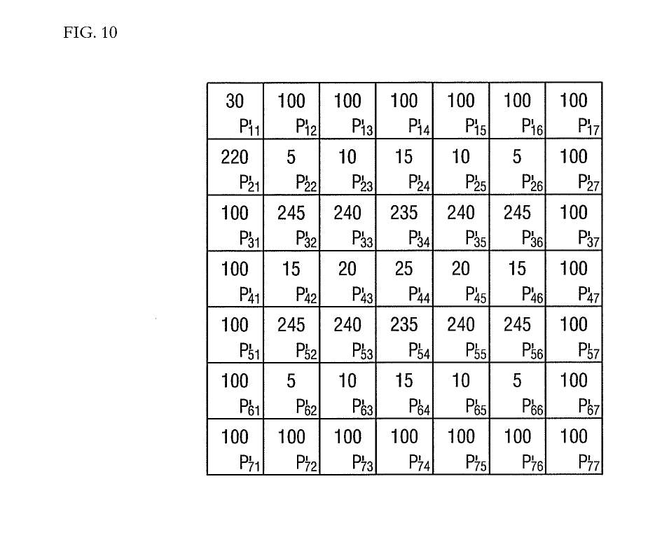

FIG. 10 illustrates a frame of corrected frame data and the pixels which are to emit light based on the data in the frame according to a fourth exemplary embodiment. The exemplary embodiment of FIG. 10 is the same as the exemplary embodiment of FIG. 9, but with an exception. Referring to FIG. 10, in the corrected frame data RFD, the grayscale values of pixels in a row stripe pattern area may be varied by different amounts. This is in contrast to the exemplary embodiment of FIG. 9, in which the grayscale values of the black or white pixels in the row stripe pattern area are increased or lowered by the same amount, e.g., 15.

For example, the grayscale values of light emitted by the pixels P₂₂, P₂₆, P₆₂, and P₆₆ at the corners of the row stripe pattern area may be varied by a value of 5, and the grayscale value of light emitted by a pixel P₄₄ at the center of the row stripe pattern area may be varied by a value of 25. Thus, the grayscale values of pixels close to the edges of the row stripe pattern area may be varied by a smaller amount than the grayscale values of pixels less close to the edges of the row stripe pattern area, and the grayscale values of pixels close to the center of the row stripe pattern area may be varied by a greater amount than the grayscale values of pixels less close to the center of the row stripe pattern area. Accordingly, an image corresponding to the corrected frame data RFD with gradual variations in grayscale values from one pixel to another pixel may be displayed on the display panel 500 with a smoother gradation of contrast than an image corresponding to the corrected frame data RFD with non-gradual variations in grayscale.

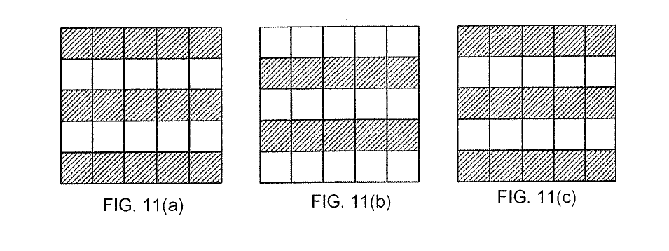

FIGS. 11(a), 11(b), and 11(c) illustrate examples of frames of raw frame data for different scroll speeds and pixels that emit light based on the data in each of the frames. FIG. 11(a) illustrates an example of a previous frame of the raw frame data FRD. For convenience, it is assumed that the entire frame in FIG. 11(a) is classified as a stripe pattern area, and that the display device has a driving frequency of 60 Hz.

FIG. 11(b) illustrates an example of a current frame of the raw frame data FRD. When the scroll speed during the display of an image from the previous frame of FIG. 11(a) to the current frame of FIG. 11(b) is 60 Hz, each pixel moves by one pixel unit per frame. In this case, all pixels may experience drastic variations in grayscale value. Referring to FIGS. 11(a) and 11(b), the pixels in first, third, and fifth rows of the previous frame are black pixels and the pixels in second and fourth rows of the previous frame are white pixels. On the other hand, the pixels in first, third, and fifth rows of the current frame are white pixels, and pixels in second and fourth rows of the current frame are black pixels. Thus, drastic variations in grayscale value between the previous frame and the current frame occurs. In this case, a flicker phenomenon may be easily noticeable. Thus, the data processor 130 may increase the amount by which to vary the grayscale values of pixels in a stripe pattern area.

FIG. 11(c) illustrates another example of the current frame of the raw frame data FRD. When the scroll speed during the display of an image from the previous frame of FIG. 11(a) to the current frame of FIG. 11(c) is 120 Hz, each pixel moves by two pixels unit per frame, In this case, each pixel may not experience any variation in grayscale value. Referring to FIGS. 11(a) and 11(c), the pixels in the first, third, and fifth rows of the previous frame and the pixels in the second and fourth rows of the previous frame are black pixels and white pixels, respectively. The pixels in first, third, and fifth rows of the current frame and pixels in second and fourth rows of the current frame are also black pixels and white pixels, respectively. Thus, only a small variation no variation at all in grayscale value occurs. In this case, a flicker phenomenon may not necessarily be easily noticeable. Thus, the data processor 130 may reduce the amount by which to vary the grayscale values of pixels in a stripe pattern area.

In the examples of FIGS. 11(b) and 11(c), it is assumed that an image is scrolled at the same speed as, or a speed two times higher than, the driving frequency of the display panel 500. In another embodiment, the image may be scrolled at a different speed (e.g., three times higher or more) than the driving frequency of the display panel 500.

In one embodiment, the data processor 130 may output corrected frame data RFD with a larger variation in grayscale value for a scroll speed close to an odd number multiple of the driving frequency of the display panel 500, than for a scroll speed close to an even number multiple of the driving frequency of display panel 500.

The data processor and other controller or computing features of the invention may be implemented in logic which, for example, may include hardware, software, or both. When implemented at least partially in hardware, the data processor, controller, or other computing features may be, for example, any one of a variety of integrated circuits including but not limited to an application-specific integrated circuit, a field-programmable gate array, a combination of logic gates, a system-on-chip, a microprocessor, or another type of processing or control circuit.

When implemented in at least partially in software, the data processor, controller, or other computing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods described herein.

By way of summation and review, many electronic devices have displays. Most of these devices are user controlled. For example, a user may control the functions of an electronic device with an input device, often in various operating states and/or during the execution of programs. When all information of an image cannot be displayed at the same time on a display screen because the size of the screen or device is limited, a user may control the position of the image by vertically or horizontally scrolling the image. However, during scrolling, the image may tremble, vibrate, or flicker, e.g., generically referred to as a flicker phenomenon. These effects may become pronounced when the image has a particular pattern such as a stripe pattern, checker pattern, block pattern, or another pattern.

In accordance with one or more of the aforementioned embodiments, a data correction unit reduces or prevents the flicker phenomenon associated with at least part of a having with a particular pattern during a scroll operation performed by a user. The data correction unit may generate the corrected frame data RFD by correcting the grayscale values for pixels in raw frame data.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. A data correction apparatus, comprising:
a pattern detector to detect a predetermined pattern area in raw frame data and to output pattern data corresponding to the predetermined pattern area;
a scroll detector to detect a scroll operation based on user manipulation data and to output scroll data corresponding to the scroll operation; and
a data processor to output corrected frame data or non-corrected frame data based on the raw frame data, the pattern data, and the scroll data, wherein the corrected frame data includes first area data and second area data, the first area data identical to a counterpart of the raw frame data and the second area data to be obtained by correcting a counterpart of the raw frame data, and wherein the non-corrected frame data is identical to the raw frame data.

2. The apparatus as claimed in claim 1, wherein the data processor is to:
output the corrected frame data based on the pattern data indicating existence of the predetermined pattern area, the scroll data indicating existence of the scroll operation, and the scroll data indicating that a scroll speed corresponding to the scroll operation exceeds a predefined scroll speed, and
output the non-corrected frame data based on to the pattern data indicating nonexistence of the predetermined pattern area, the scroll data indicating nonexistence of the scroll operation, or the scroll data indicating that the scroll speed corresponding to the scroll operation does not exceed the predefined scroll speed.

3. The apparatus as claimed in claim 2, wherein:
the raw frame data includes information corresponding to grayscale values of a plurality of pixels of a frame, and
the pattern detector is to detect the grayscale values of the pixels from the raw frame data, black pixels with a grayscale value less than a first grayscale value and white pixels with a grayscale value less than a second grayscale value, and a predetermined pattern area that includes the black pixels and the white pixels.

4. The apparatus as claimed in claim 3, wherein the first area data corresponds to an area other than the predetermined pattern area and the second area data corresponds to the predetermined pattern area.

5. The apparatus as claimed in claim 4, wherein the corrected frame data includes second area data in which the black pixels are corrected to have a greater grayscale value than in the raw frame data and the white pixels are corrected to have a smaller grayscale value than in the raw frame data.

6. The apparatus as claimed in claim 5, wherein the predetermined pattern area includes:
a row stripe pattern area including m pixels in a row direction and n pixels in a column direction, the black pixels or the white pixels continuously arranged in the row direction, and the black pixels and the white pixels alternately arranged in the column direction, and
a column stripe pattern area including m pixels in the row direction and n pixels in the column direction, the black pixels or the white pixels continuously arranged in the column direction, and the black pixels and the white pixels alternately arranged in the row direction.

7. The apparatus as claimed in claim 6, wherein the data processor is to:
generate the corrected frame data for part of the raw frame data corresponding to the row stripe pattern area based on the scroll operation associated with a movement in the column direction, and
generate the corrected frame data for part of the raw frame data corresponding to the column stripe pattern area based on the scroll operation being associated with a movement in the row direction.

8. The apparatus as claimed in claim 5, wherein the data processor is to output corrected frame data with larger variations in grayscale value in pixels close to a center of the predetermined pattern area than in pixels less close to the center of the predetermined pattern area.

9. The apparatus as claimed in claim 5, wherein the data processor is to output corrected frame data with larger variations in grayscale value for a scroll speed close to an odd number multiple of a driving frequency of a display device than for a scroll speed close to an even number multiple of the driving frequency of the display device.

10. The apparatus as claimed in claim 4, wherein:
each of the pixels includes a plurality of sub-pixels to emit light of different, and
the pattern detector is to determine black pixels to correspond to ones having an average of grayscale values of sub-pixels less than the first grayscale value, and white sub-pixels to correspond to ones having an average of grayscale values of sub-pixels greater than the second grayscale value.

11. The apparatus as claimed in claim 10, wherein the sub-pixels respectively emit red, green, and blue light.

12. The apparatus as claimed in claim 1, wherein the pattern detector is to provide the raw frame data to the data processor, and wherein the data processor is to receive the raw frame data from the pattern detector.

13. A display device, comprising:
a data corrector to output corrected frame data or non-corrected frame data, the corrected frame data based on based on raw frame data; and
a display panel to display an image corresponding to the corrected frame data or the non-corrected frame data, wherein the data corrector includes:
a pattern detector to detect a predetermined pattern area from the raw frame data and to output pattern data corresponding to the predetermined pattern area,
a scroll detector to detect a scroll operation based on user manipulation data and to output scroll data regarding the scroll operation, and
a data processor to output the corrected frame data or the non-corrected frame data based on the raw frame data, the pattern, data and the scroll data,
wherein the corrected frame data includes first area data identical to a counterpart of the raw frame data and second area data obtained by correcting a counterpart of the raw frame data, and wherein the non-corrected frame data is identical to the raw frame data.

14. The display device as claimed in claim 13, wherein the data processor is to:
output the corrected frame data based on the pattern data indicating existence of the predetermined pattern area, the scroll data indicating existence of the scroll operation, and the scroll data indicating that a scroll speed corresponding to the scroll operation exceeds a predefined scroll speed, and
output the non-corrected frame data based on the pattern data indicating nonexistence of the predetermined pattern area, the scroll data indicating nonexistence of the scroll operation, or the scroll data indicating that the scroll speed corresponding to the scroll operation does not exceed the predefined scroll speed.

15. The display device as claimed in claim 14, wherein:
the raw frame data includes information regarding grayscale values of a plurality of pixels in a frame, and
the pattern detector is to detect the grayscale values of the pixels from the raw frame data, black pixels with a grayscale value less than a first grayscale value and white pixels with a grayscale value less than a second grayscale value, and a predetermined pattern area that includes the black pixels and the white pixels.

16. The display device as claimed in claim 15, wherein the first area data corresponds to an area other than the predetermined pattern area and the second area data corresponds to the predetermined pattern area.

17. The display device as claimed in claim 16, wherein the corrected frame data includes second area data in which the black pixels are corrected to have a greater grayscale value than in the raw frame data and the white pixels are corrected to have a smaller grayscale value than in the raw frame data.

18. The display device as claimed in claim 17, wherein the predetermined pattern area includes:
a row stripe pattern area including m pixels in a row direction and n pixels in a column direction, the black pixels or the white pixels continuously arranged in the row direction, and the black pixels and the white pixels alternately arranged in the column direction, and
a column stripe pattern area including m pixels in the row direction and n pixels in the column direction, the black pixels or the white pixels continuously arranged in the column direction, and the black pixels and the white pixels alternately arranged in the row direction.

19. The display device as claimed in claim 18, wherein the data processor is to generate:
the corrected frame data for part of the raw frame data corresponding to the row stripe pattern area based on the scroll operation associated with a movement in the column direction, and
the corrected frame data for part of the raw frame data corresponding to the column stripe pattern area based on the scroll operation being associated with a movement in the row direction.

20. The display device as claimed in claim 17, wherein the data processor is to output corrected frame data with larger variations in grayscale in pixels close to a center of the predetermined pattern area than in pixels less close to the center of the predetermined pattern.

21. The display device as claimed in claim 17, wherein the data processor is to output corrected frame data with larger variations in grayscale for a scroll speed close to an odd number multiple of a driving frequency of a display device than for a scroll speed close to an even number multiple of the driving frequency of the display device.

22. A data correction method, comprising:
detecting a predetermined pattern area based on raw frame data and outputting pattern data regarding the predetermined pattern area;
detecting a scroll operation based on user manipulation data and outputting scroll data regarding the scroll operation; and
outputting corrected frame data or non-corrected frame data based on the raw frame data, the pattern data, and the scroll data.

23. The method as claimed in claim 22, wherein outputting the corrected frame data or the non-corrected frame data includes:
outputting the corrected frame data based on the pattern data indicating existence of the predetermined pattern area, the scroll data indicating existence of the scroll operation, and the scroll data indicating that a scroll speed corresponding to the scroll operation exceeds a predefined scroll speed, and
outputting the non-corrected frame data based on the pattern data indicating no predetermined pattern area, the scroll data indicating no scroll operation, or the scroll data indicating that the scroll speed corresponding to the scroll operation does not exceed the predefined scroll speed.

24. The method as claimed in claim 23, wherein the raw frame data includes:
information corresponding to grayscale values of a plurality of pixels in a frame, and
detecting the predetermined pattern area includes detecting the grayscale values of the pixels from the raw frame data, black pixels with a grayscale value less than a first grayscale value, and white pixels with a grayscale value less than a second grayscale value, and detecting a predetermined pattern area formed by the black pixels and the white pixels.

25. The method as claimed in claim 24, wherein outputting the corrected frame data includes generating corrected frame data in which the black pixels are corrected to have a greater grayscale value than in the raw frame data and the white pixels are corrected to have a smaller grayscale value than in the raw frame data.

26. The method as claimed in claim 25, wherein outputting the corrected frame data includes outputting corrected frame data with larger variations in grayscale value in pixels close to a center of the predetermined pattern area than in pixels less close to the center of the predetermined pattern.

27. The method as claimed in claim 25, wherein outputting the corrected frame data includes outputting corrected frame data with larger variations in grayscale value for a scroll speed close to an odd number multiple of a driving frequency of a display device than for a scroll speed close to an even number multiple of the driving frequency of the display device.
